(19) United States
(12) Patent Application Publication
(10) Pub. No.: US 2026/0232516 A1
(43) Pub. Date: Aug. 13, 2026

(54) SYSTEMS AND METHOD FOR MOBILIZING A LOW BACK OF A HUMAN SUBJECT

(71) Applicant: ODIX, Thimister-Clermont (BE)

(72) Inventors: Francis Emile Jean Frankenne, Chaudfontaine (BE); Valérie Fernande Jeanne Gordenne, Thimister-Clermont (BE); Xavier Gérard Monique Delcorps, Neufchâteau (BE); Sophie Franiçoise Christophe Deflandre, Grivegnée (BE)

(21) Appl. No.: 19/155,249

(22) PCT Filed: Jan. 31, 2024
(86) PCT No.: PCT/EP2024/052366

§ 371 Date: Aug. 10, 2025

(30) Foreign Application Priority Data
Feb. 23, 2023 (EP) 23158264.4

(51) Int. Cl. A61H 1/02

(52) U.S. Cl. CPC A61H 1/0292; A61H 2201/1223; A61H 2201/1633; A61H 2201/164; A61H 2201/1671; A61H 2201/5007

(57) ABSTRACT

A system for mobilizing a low back of a human subject, wherein the system comprises: a seating platform, comprising a seat having a seating surface for supporting the buttocks of the human subject, wherein a first centre axis of the seating surface extends a first horizontal direction; wherein the seating platform is configured to seat the human subject with the legs in front of the seat when seen in a second horizontal direction, wherein the second horizontal direction is perpendicular to the first horizontal direction; an actuating system configured to move the seating platform with a plurality of degrees of freedom, wherein one of the degrees of freedom is a rotation around a horizontal rotation axis with extends parallel to the first horizontal direction, wherein the horizontal rotation axis is offset from the first centre axis when seen in the second horizontal direction.

### CROSS-REFERENCE TO RELATED APPLICATION(S)

This application is a Section 371 National Stage Application of International Application No. PCT/EP2024/052366, filed on Jan. 31, 2024, entitled “Systems and Method for Mobilizing a Low Back of a Human Subject”, which claims priority to European Patent Application No. 23158264.4, filed Feb. 23, 2023, which are incorporated herein in their entirety by reference.

### BACKGROUND

The present disclosure relates to the field of systems and a method for mobilizing a low back of a human subject.

Mobilizing the low back can e.g. be used to treat low back pain. Low back pain is one of the most common causes of disability worldwide. It has a huge impact on the patients themselves, but also a financial impact on the social security and on companies. The number of patients is only expected to increase in the next decades.

Different issues with low back (muscles) are known. For example, in some cases of low back injuries, the low back pain is associated with a mechanical overburden of some sort, without a specific anatomical pain generator that can be pointed out. These are called Non-Specific Low Back Pain (NS-LBP) and represent 90% of the so-called Low Back Pain diseases. These NS-LBP may become chronical.

Different treatment programs have been proposed to treat low back injuries. Generally, it is considered that physical treatment is recommended, wherein the patient remains active via an exercise program. However, there remain large inconsistencies in the type of exercise program (yoga, stretching, hydrotherapy exercises, tai chi, and back schools) being used, and in the way that it is delivered (group exercise individual programs, or supervised home exercise). The treatments may even differ from practitioner to practitioner within the same type of exercise. The efficacy of those treatments is also very variable from patient to patient. This makes low back pain a complex pathology to treat with no recognized physical treatment gold standard.

The existing training programs all have their own advantages and disadvantages. However, a common factor is that they require active exercise from the patient. When a patient is afraid of inflicting pain on himself by doing the exercise, the exercise may not be performed adequately and the (desired) effect may not be achieved.

Several devices have been proposed to stimulate the back muscles, for example by applying pressure or movement with external devices. This is e.g. done is massage chairs and similar apparatuses. However, these devices are not satisfactory for a long-term treatment of low back pain.

### SUMMARY

Although treating low back pain is a possible application of the present disclosure, the present disclosure can also be used for other purposes, generally mobilizing the low back. For example, the present disclosure can be used to train the low back, prevent low back injuries, mobilize the trunk, for neurological injuries rehabilitation.

It is an object of the present disclosure to overcome the disadvantages of the prior art, or at least provide an alternative to the prior art. It is in particular an object of the present disclosure to provide a solution for mobilizing the low back of a human subject.

One or more objects of the present disclosure are achieved with a system for mobilizing a low back of a human subject, wherein the system includes:
a seating platform,
comprising a seat having a seating surface for supporting the buttocks of the human subject, wherein a first centre axis of the seating surface extends a first horizontal direction;
wherein preferably the seating platform is configured to seat the human subject with the legs in front of the seat when seen in a second horizontal direction, wherein the second horizontal direction is perpendicular to the first horizontal direction;
an actuating system configured to move the seating platform with a plurality of degrees of freedom, wherein preferably one of the degrees of freedom is a rotation around a horizontal rotation axis with extends parallel to the first horizontal direction, wherein preferably the horizontal rotation axis is offset from the first centre axis when seen in the second horizontal direction.

The present disclosure thus relates to a system for mobilizing a human subject. The system can e.g. be used for treating a human subject. The human subject can e.g. be a patient. The human subject may be suffering from an injury or disability at the low back. The human subject may e.g. suffer from Non-Specific Low Back Pain (NS-LBP), optionally being chronical. However, it is also envisaged that the present disclosure may be used for mobilizing human subjects without (large) injuries to prevent such large injuries. In such cases the mobilizing of the low back e.g. entails training the low back muscles. The system can e.g. be configured to improve the pathology of a human subject. It is also envisaged that the present disclosure may be used for mobilizing human subjects with no or moderate pathology, for example to recover after physical exercise and/or for core stability training. It is also envisaged that the present disclosure may be used for treating a human subject suffering from specific low back pain, e.g. after surgery. It is also envisaged that the present disclosure may be used in stroke rehabilitation or neurological (injuries) rehabilitation. It is also envisaged that the present disclosure can be used in combination with and/or as support for another treatment method, e.g. any of the conventional treatments explained above.

In particular the low back of the human subject can be treated. The low back region is also referred to as the lumbar region. The lumbar region includes various muscles and tissues. The system may e.g. be used to mobilize at least some of the muscles and/or tendons and/or joints in the lumbar region. The system may e.g. be used to mobilize the lumbosacral joint. Mobilizing the low back can e.g. include causing low back movements; and/or improving muscle recruitment patterns; and/or causing muscle contractions and relaxations; and/or improving low back mobility.

The system includes a seating platform and an actuating system. The human subject can sit on the seating platform. The actuating system is configured to move the seating platform, and thus the human subject when the human subject is seated. The human subject, in particular the low back, can as such be mobilized by the system. This is a passive and/or reactive movement, since the human subject does not initiate the movement himself. This is a first advantage of the system. Some human subjects may have psychological barriers to start moving their low back, out of fear for hurting themselves. These human subjects do not manage to effectively apply the conventional training programs. With the present system, they will be forced to move the low back in the passive and/or reactive manner. This may help those human subjects to overcome said psychological barrier.

The seating platform includes at least a seat having a seating surface for supporting the buttocks of the human subject. The seating platform is thus configured for seating the human subject on the seating surface. The seat may e.g. include any suitable material for a seat, e.g. foam on the interior and a leather or synthetic material on the outside. The seat may e.g. have a substantially cubic shape. The seating surface may e.g. have a substantially rectangular shape. The seat may e.g. have a height (e.g. extending in a vertical direction), and a width and length (e.g. extending in perpendicular horizontal directions), wherein the width and smaller the length are both larger than the height, e.g. at least two times larger, e.g. at least three times larger, e.g. at least five times larger.

The seating platform includes a first centre axis which extends in a first horizontal direction. As will be seen further below, the first direction may extend between the left-handed side and the right-handed side of the human subject when the human subject is seated on the seat. Optionally, a second centre axis extends in a direction which is perpendicular to the first centre axis, e.g. a second horizontal direction. Optionally, a third centre axis extends in a direction which is perpendicular to the first centre axis and optionally also to the centre axis, e.g. the third centre axis may extend in a vertical direction. It is noted that these orientations may relate to a rest position or begin position of the system, i.e. before the actuating system moves the seating platform. This may also be the position in which the human subject can move on or off the seating platform.

Preferably, the seating platform is configured to seat the human subject with the legs in front of the seat. In front is seen in a second horizontal direction, which is perpendicular to the first direction. Thus, the second horizontal direction may extend between the rear side (behind the human subject) and the front side (in front of the human subject) of the human subject when the human subject is seated on the seat. In front is into the direction in which the face and breast surface of the human subject are directed when seated. The legs of the human subject are thus arranged in front of the upper body, although the legs may be arranged at a lower vertical level. The legs are not arranged on opposite sides of the seat, but instead are both arranged in front of the seat. In some embodiments, the upper legs may be (at least partly) supported by the seating surface, and the lower legs and feet are arranged in front of the upper body.

It has been found that the seating position with the legs in front of the seat is advantageous for efficiently causing (passive and/or reactive) movement of the low back when the seating platform is being moved. In practice this may be implemented in several ways. For example, a footrest may be arranged in front of the seat. This may make it intuitive for the human subject to place the feet in the footrest and thus in front of the seat. For example, in addition or alternatively, the seating surface (and/or components arranged below the seating surface) may extend up to a width in the second direction, wherein the width prevents a human subject from arranging the legs on opposite sides (e.g. left and right) of the seat. This, the seating surface is so wide that the human subject can only place the legs in front of the seat.

The actuating platform is configured to move the seating platform with a plurality of degrees of freedom. Each degree of freedom may e.g. relate to a translation or to a rotation. For example, said plurality may include two, three, four, five, or six degrees of freedom. The actuating platform may e.g. include a plurality of actuators for moving the seating platform, e.g. one actuator for each degree of freedom. The actuating system can be any type of suitable actuating system that can accomplish the desired number of degrees of freedom. The actuating platform may e.g. include a parallel manipulator configured to move an end-effector, wherein the seat is connected to said end-effector. The actuating platform may e.g. include a Stewart platform. The actuators may e.g. be electric, hydraulic, magnetic, or pneumatic actuators/motors. The actuating platform may e.g. include a control unit configured to control the actuators.

Preferably, one of the degrees of freedom is a rotation around a horizontal rotation axis with extends parallel to the first horizontal direction. Thus, the horizontal rotation axis may extend between the left-handed side and the right-handed side of the human subject when the human subject is seated on the seat. The rotation around this axis is configured to tilt the human subject forwards or backwards. It has been found that this rotation is advantageous for mobilizing the low back (e.g. including the low back muscles, and/or the lumbosacral joint, and/or disks in the low back) of the human subject. It is theorized that this is because the human subject is brought out of natural balance, and mobilizing the low back is needed during the natural reaction of the human subject to restore the balance, thus for returning to a balanced position. As such, the muscles, and/or tendons, and/or lumbosacral joint can be mobilized.

In embodiments, the horizontal rotation axis is offset from the first centre axis when seen in the second horizontal direction. Thus, the horizontal rotation axis is not arranged in the centre of the seating surface. It has been found that, although being counterintuitive in the mechanical design of the system, offsetting the horizontal rotation axis from the centre axis improves the mobilization of the low back. In this arrangement, the rotation causes the human subject to easier become unbalanced, which forces the human subject to use the low back to restore the balance.

It is noted that in some embodiments, another one of the degrees of freedom is a rotation around a second horizontal rotation axis. The second horizontal rotation axis extends perpendicular to the horizontal rotation axis and thus also to the first horizontal direction. A centre of rotation can be defined where the horizontal rotation axis and the second horizontal rotation axis intersect. The centre of rotation is optionally offset from the first centre axis when seen in the second horizontal direction.

In embodiments, the horizontal rotation axis is arranged behind the second centre axis when seen in the first horizontal direction. Behind is the opposite side of in front. Thus, the horizontal rotation axis is configured to be arranged closer to the back of the human subject than to the feet of the human subject. The transmission of movement from the seating platform to the (low) back can be improved, e.g. forcing the human subject to use the low back more when restoring the balance, thereby further improving mobilization of the low back.

In embodiments, the seating surface is configured to seat the human subject with the back being positioned substantially above the horizontal rotation axis. This forces the human subject to use the low back more when restoring the balance, thereby further improving mobilization of the low back. The system (e.g. the seating platform and/or the footrest when present) can e.g. be designed in a way that incentivizes the human subject to seat himself/herself on a predetermined position, e.g. with the back being positioned substantially above the horizontal rotation axis. For example, the dimensions of the seating surface can be configured for that, and/or the relative positions of the footrest (when present) and the seating surface can be configured for that.

In embodiments, the seating platform is configured to support the human subject backrestless, at least during use. Thus, during use, the human subject is not resting the back against a backrest. The seating platform does not include a backrest (during use). The seating platform is backrestless (or backless) (during use). During use relates to when the actuating system is moving the platform. It has been found that the human subject is forced to use the low back more to restore the balance when the back is not resting against a backrest. Therefore, these embodiments enhance the mobilization of the low back.

It is noted that even in embodiments where the seating platform is configured to support the human subject backrestless during use, the system may still include a back-safeguard. The back-safeguard may be implemented as a backrest, e.g. at a distance from the seating surface. For example, when seen in the second horizontal direction, the back-safeguard may be arranged at a distance of the seating surface. The back-safeguard is configured to prevent the human subject from falling backwards of the seat. During use, however, back-safeguard is not configured to engage the human subject.

It is noted that, nevertheless, also embodiments are possible in which the seating platform includes a backrest. This may e.g. be useful for human subjects having difficulties with sitting and/or having a balance disorder.

In embodiments, the seating platform is configured to support the human subject armrestless, at least during use. Thus, during use, the human subject is not resting the arms or hands on an armrest. During use relates to when the actuating system is moving the platform. It has been found that the human subject is forced to use the low back more to restore the balance when the arms or hands cannot find support on an armrest for restoring the balance. Therefore, these embodiments enhance the mobilization of the low back.

It is noted that even in embodiments where the seating platform is configured to support the human subject armrestless during use, optionally the seating platform may also include side-safeguards. The side-safeguards may e.g. be configured to prevent the human subject from falling sidewards of the seating platform. Optionally, the side-safeguards are embodiment as arm-rails, e.g. at a distance from the seating surface. This may enable the human subject to find support with the arms or hands on the arm-rails when risking falling off.

In embodiments, the seating platform includes a footrest for supporting both feet of the human subject. In embodiments wherein the seating platform is also configured to seat the human subject with the legs in front of the seat, the footrest may be arranged in front of the seat when seen in the second horizontal direction. The footrest may include a single footresting surface for both feet; or a left footresting surface for the left foot and a right footresting surface for the right foot.

The footrest is part of the seating platform. Since the actuating system moves the seating platform, the actuating platform is also configured to move the footrest. Thus, the human subject is being moved completely. The feet are not being held stationary. It has been found that this is advantageous to improve the mobilization of the low back. The footrest may e.g. be rigidly connected to the seat, optionally via a platform frame. The rigid connection ensures that the seat and footrest move in cohesion.

In embodiments, the footrest includes a size adjustment mechanism for adjusting the position of the footrest relative to the seat. For example, the footrest may be rigidly connected to the seat via a connection bare, wherein the size adjustment mechanism is configured to allow adjusting. These embodiments allow adapting the footrest to the length of the (legs of the) patient. Optionally, the size adjustment mechanism is manually adjustable.

In embodiments, the footrest includes a footresting surface, wherein the footresting surface extends at an acute angle to the horizontal when seen in the second horizontal direction. Optionally, the footresting surface may extend partially upwards when seen in a forward direction. The forward direction extends to the front, i.e. generally away from the seat (and thus away from the human subject when seated) when seen in the second horizontal direction. The feet of the human subject will thus be arranged tilted on the footresting surface. It has been found that this causes the human subject to use the feet less to restore the balance during the movement of the seating platform. Thus, the human subject will use the low back more.

The footresting surface may e.g. include a single footresting surface for both feet, wherein said single footresting surface extends at the acute angle; or a left footresting surface for the left foot and a right footresting surface for the right foot, wherein both the left and right footresting surface extend at the acute angle.

In embodiments, the seat, e.g. the seating surface, further supports at least a part of the upper legs, optionally substantially the entire upper legs. For example, the seat may be configured to position to upper legs horizontally, when the seating platform is in rest position or begin position. For example, the seating surface may be large enough to support both the buttocks and the upper legs. This may in particular be advantageously combined with seating the human subject with the legs in front of the seat.

In embodiments, the system (in particular the seating platform) is configured to support the human subject (e.g. during use) in a manner that allows the human subject to move freely above the waist. In embodiments, the system (in particular the seating platform) is configured to support the human subject (e.g. during use) by only engaging body parts below the waist. In embodiments, the system (in particular the seating platform) is configured to support the human subject (e.g. during use) only at the buttocks, and/or legs, and/or feet. In embodiments, the system (in particular the seating platform) does not include any support elements for supporting body parts of the user above the waist. In embodiments, all supports of the system (in particular the seating platform) that are configured to engage the human subject during use, are configured to engage a body part below the waist.

These embodiments, which can be applied in any combination with each other or separately, ensure that the human subject has freedom of movement of the back muscles. The movement of the seating platform will cause unbalance of the human subject (amongst others because the back is not fixed in position), and the human subject will naturally use the low back muscles to restore the balance. As such, the low back is mobilized. It is noted that these embodiments can e.g. be implemented with the features of supporting the human subject backrestless and/or armrestless, as described herein.

In embodiments, the system is configured to support the human subject in a manner the human subject to move relative to the system. For example, the system is configured to support the human subject strapless and beltless (without straps or belts). Thus, the human subject is not strapped tight to the seating platform. For example, the back, arms, and head can move relative to the system (in particular the seating platform. Optionally also the legs and feet can move relative to the system, in particular the seating platform, in particular the footrest.

In embodiments, the system is configured to bring the human subject out of balance (e.g. by moving the seating platform with the actuating system), and force the human subject to restore the balance by mobilizing the low back muscles. These embodiments can e.g. be achieved with one or more of the herein described features, e.g. the system or seating platform being backrestless, armrestless, allowing the subject to move freely above the waist, only supporting the human subject below the waist (e.g. at buttocks, and/or legs, and/or feet), not having support elements above the waist, etc.

The above embodiments describe several advantageous aspects of the system in various embodiments, which e.g. relate to how the human subject is seated on the system and/or supported by the system. These embodiments have several advantages as elaborated herein. Below, further advantageous embodiments are described, e.g. relating to how the movement of the seating platform can be controlled (e.g. by a control unit). All embodiments described herein can advantageously be combined to achieve synergistic effects, e.g. combining how the patient is seated/supported with how the seating platform is moved. However, these embodiments are not limited to such embodiments. That is, any of the embodiments described below regarding the movement of the seating platform, can also be implemented with systems having a different type of seating platform (supporting and/or seating the human subject differently than in embodiments described above). Similarly, the system with seating platform according to any of the embodiments described above, can also be moved in other ways (e.g. other actuating systems, other trajectories, other rotation/acceleration speed/limits) than the embodiments described below.

In embodiments, the system further includes a control unit configured to control the actuating system, wherein the control unit is optionally configured to limit the acceleration of the seating platform to a predetermined acceleration limit. For example, the acceleration limit may include a translational acceleration limit, which may e.g. be 4 m/s² or less, e.g. 2.5 m/s², e.g. 1.5 m/s². For example, the acceleration limit may include a rotational acceleration limit, which may e.g. be 70°/s² or less, e.g. 58°/s², e.g. be 45°/s². The acceleration limit can e.g. relate to the acceleration of the centre of rotation of the actuating system, or at the centre of the seat or seating surface.

Limiting the acceleration to the acceleration limit has been found advantageous for mobilizing the low back of the human subject without causing too much stress on the low back, e.g. on the low back muscles or lumbosacral joint. If the seating platform would accelerate too quickly, this may inflict pain on a human subject with low back injury. It may also be possible that the back is subjected to too much shear, which can be painful.

The acceleration limits may furthermore be particularly advantageous in embodiments wherein the human subject is supported backrestless during use. Not being able to support the back, makes it more difficult for the human subject to maintain the balance. If the acceleration would become too large, a risk may be created for the human subject to fall of the seating surface. It has in particular be found advantageous to use the translational acceleration limit of 2.5 m/s² and the rotation acceleration limit of 58°/s² in these embodiments.

The control unit can be any type of suitable type of control unit, e.g. being embodied in a computer, PLC, raspberry pi, or the like. The control unit can optionally be configured to control additional parts of the system (such information lights for transmitting information to the practitioner or human subject or an input button/panel for allowing the practitioner or human subject to input preferences such as an intensity input), or be configured to be in communication with additional control units for controlling such additional parts. The control unit can e.g. control the different actuators directly, or indirectly by means of an actuating system control unit configured to control the actuators and be in communication with the control unit. The control unit can e.g. include one or more input terminals, output terminals, or communication terminals for communicating with other components. Said communication can be wired or wireless, according to any of suitable communication method or protocol, e.g. using Bluetooth or a Wi-Fi network. The control unit can e.g. be configured to be in communication with a cloud-based platform. The control unit can e.g. include a processing unit. The control unit can e.g. include a memory, e.g. for storing computer-readable instructions. It is noted that, in embodiments, the control unit can also be present without being configured to limit the acceleration of the seating platform to the predetermined acceleration limit.

In embodiments, the control unit is configured to control the actuating system based on desired subsequent positions of the seating platform. For example, a desired position may be determined for each predetermined moment in time, for example for every 10-25 ms, e.g. approximately every 15 ms, e.g. every 16 ms. The control unit may then be configured to control the actuating system to the desired subsequent position, and thereafter to the respective desires subsequent position, and so on. The control unit may e.g. include a processing unit for determining on or more control signals for the actuating system based on the desired subsequent positions.

For example, in some embodiments, the control unit may be configured to determine a desired subsequent position based on predetermined equations, wherein optionally the control unit may receive an intensity input, and select or adapt the predetermined equations based on the intensity input. The intensity input may e.g. be set by the human subject or a practitioner, e.g. with an intensity input module on the system. The control unit may e.g. include an input terminal for receiving the intensity input. The control unit may e.g. include a memory for storing the predetermined equations.

For example, in some embodiments, the control may be configured to receive the desired subsequent positions. The control unit may e.g. include an input terminal for receiving the desired subsequent positions. The control unit may e.g. be configured to receive the desired subsequent positions from an external control unit. The control unit may e.g. be configured to communicate with the external control unit via a cloud-based platform, e.g. using an internet protocol communication technique.

In embodiments, the control unit may be configured to determine the required acceleration (e.g. the rotational acceleration and translational acceleration) to move the seating platform from a first position to a desired subsequent second position. The control unit may further be configured to compare the required acceleration with the acceleration limit (e.g. the rotational acceleration limit and translational acceleration limit). If the required acceleration exceeds the acceleration limit, the control unit may be configured to determine an alternative second position for which an alternative required acceleration is below the acceleration limit, and/or the control unit may be configured to determine an alternative velocity for moving the seating platform from the first position to the subsequent second position and/or the alternative second position. The control unit may then be configured to control the actuating system in accordance with the alternative second position and/or alternative velocity, e.g. to move from the first position to the alternative second position or to move from the first position to the second position at the alternative velocity.

Thus, in these embodiments, it is first determined what is required to move to the desired subsequent position. This includes determining the acceleration, and possibly also the velocity. If the acceleration exceeds the acceleration limit, measures are taken to correct this. This may include to change the subsequent second position to an alternative second position. The alternative second position can e.g. be closer to the first position, so that the required acceleration is smaller. Another measure that can be taken, is to lower the velocity and thus move slower to the subsequent second position. Since the velocity is lower, the required acceleration to reach said velocity is also lower.

In embodiments, the system further includes an auxiliary system for helping the human subject maintain a straight sitting position on the seating surface. In this context, a straight sitting position refers to the back, in particular the upper back and the shoulders, of the human subject being substantially straight. It has been found that the low back is mobilized more and/or better when the human subject is sitting in a straight sitting position. In practice, however, many people have a difficult time maintaining the straight sitting position. This is even more problematic for people having (low) back injuries.

Optionally, the auxiliary system is configured to help the human subject contactless. For example, the auxiliary system can be a mirror arranged in front of the seating platform. It has been found that when human subjects see themselves in the mirror, they notice when their sitting position is not straight, and they tend to correct this as much as possible. Being contactless, the advantageous effects can be achieved, without providing any additional physical support to the human subject, which could decrease the mobilization of the low back.

In embodiments, the actuating system is configured to move the seating platform in six degrees freedom. The six degrees of freedom may e.g. include three translational degrees of freedom and three rotational degrees of freedom. The three translational degrees of freedom may include translation in three perpendicular translation directions, e.g. two horizontal and one vertical direction, e.g. commonly indicated by an x-axis, y-axis, and z-axis. The three rotational degrees of freedom may include rotations around three different rotation axes, wherein each rotation axis extends parallel to one of the translation directions. The three rotational degrees of freedom can e.g. correspond with the rotations commonly indicated as pitch, roll, and yaw.

Optionally, the actuating system is a Stewart-platform. A Stewart platform is a type of parallel manipulator that has six actuators, e.g. prismatic actuators, e.g. hydraulic jacks or electric linear actuators. The six actuators are e.g. configured to move six bars which are arranged between a baseplate and a top plate. The bars can e.g. be part of the actuators. The bars can e.g. be attached in pairs to three positions on the baseplate and connected to three mounting points on a top plate. The top plate may e.g. be part of the seating platform or configured to support the seating platform.

In embodiments, the control unit is configured to move the seating platform at a low frequency, e.g. below 50 Hz, e.g. below 10 Hz, e.g. below 5 Hz, e.g. below 2 Hz. It has been found that the low back is best mobilized in a passive/reactive manner when the movement is at said low frequencies. As frequencies get higher, the movement of the seating platform becomes a vibration, which has been found to not be very effective for mobilizing the low back.

In embodiments, the control unit is configured to filter the movement of the seating platform at a cut-off frequency. The cut-off frequency can e.g. at 10 Hz or lower, e.g. at 5 Hz or lower, e.g. at approximately 4 Hz.

In embodiments, the control unit is configured to control the movement of the seating platform to be unpredictable for the human subject. If the movement becomes predictable, the human subject is able to prepare for the next movement. This would decrease the mobilization of the low back, because a human subject with low back injuries tends to prepare for said movement by positioning the human subject's position in a way that the low back (e.g. the muscles that are causing pain) is used as little as possible. The control unit may implement these embodiments by having sufficient variability in the movement. This can e.g. be achieved by combining (e.g. for each degree of freedom) a plurality of periodic movements. In some embodiments, a random generator can be used to randomize the movement.

In embodiments, the control unit is configured to control the movement of the seating platform to be reproducible. It may be desirable that the movement is reproducible for (clinical) testing, such that it can be established that a predetermined, reproducible movement achieves a clinical effect, or at least is safe for the human subject. This can e.g. be achieved by combining (e.g. for each degree of freedom) a plurality of periodic movements, which are predetermined and known, and can thus be reproduced.

A combination of the unpredictable yet reproducible movement can e.g. be achieved by combining a plurality of periodic movement, e.g. for each degree of freedom.

In embodiments, the control unit is configured to determine a desired subsequent position in each degree of freedom according to a predetermined equation per degree of freedom, wherein each predetermined equation is a combination of a plurality of periodic functions having different periods and optionally also different amplitudes. This may e.g. result in an advantageous unpredictable yet reproducible movement. The control unit may further be configured to convert the desired subsequent position into one or more control signals for the actuating system, e.g. a control signal for each actuator of the actuating system.

In embodiments, the predetermined equation for each degree of freedom may include three or more periodic functions, e.g. four periodic functions, e.g. more than four periodic functions.

In embodiments, the smallest period and the largest period of the plurality of periodic functions of the predetermined equation of the translational degrees of freedom may be within a ratio of 1:2.

In embodiments, the smallest period and the largest period of the plurality of periodic functions of the predetermined equation of the rotational degrees of freedom may be within a ratio of 1:5.

In embodiments, the period of each periodic function of the predetermined equation of each translational degree of freedom may be smaller than 2 seconds, e.g. smaller than 1.5 seconds, e.g. approximately 1 second. In embodiments, the period of each periodic function of the predetermined equation of each translational degree of freedom may be greater than 0.5 seconds.

In embodiments, the period of each periodic function of the predetermined equation of each rotational degree of freedom may be smaller than 2 seconds, e.g. smaller than 1.5 seconds, e.g. approximately 1 second. In embodiments, the period of each periodic function of the predetermined equation of each translational degree of freedom may be greater than 0.5 seconds. In embodiments, one or more of the periodic functions in a predetermined equation per degree of freedom are lagging in comparison to one or more of the other periodic functions of the same predetermined equation. For example, said periodic function can be lagging by half of a period, e.g. being implemented as a cosine function when the other periodic functions are implemented as sine functions.

In embodiments, the periodic functions may be sinusoidal functions.

In embodiments, the control unit may be configured to control, for example based on an intensity input, the intensity of the movement by adapting the predetermined functions. For example, the control unit may be configured to scale the amplitude and/or the period (or frequency) of each periodic function. For example, for the rotational degrees of freedom the amplitude of each periodic function can be scaled between 0 and 1.35. For example, for the translational degrees of freedom the amplitude of each periodic function can be scaled between 0 and 0.75. For example, for the rotational degrees of freedom the period (or frequency) of each periodic function can be scaled between 0 and 1.5. For example, for the translational degrees of freedom the period (or frequency) of each periodic function can be scaled between 0 and 1.5.

In embodiments, the control unit is configured to limit the translation of the seating platform to predetermined translation limit. For example, the translation limit may be 15 cm or less, e.g. 12 cm, e.g. 10 cm.

For example, in embodiments, the control unit is configured to control the actuating system based on desired subsequent positions of the seating platform; determine the required translation of the seating platform in a desired subsequent position; compare the required translation with the translation limit; and if the required translation exceeds the translation limit, determine an alternative second position for which an alternative required translation is below the translation limit; and control the actuating system in accordance with the alternative second position.

In embodiments, the control unit is configured to limit the rotation of the seating platform to predetermined rotation limit. For example, the rotation limit may be 15° or less, e.g. 10°, e.g. 8°.

For example, in embodiments, the control unit is configured to control the actuating system based on desired subsequent positions of the seating platform; determine the required rotation of the seating platform in a desired subsequent position; compare the required rotation with the rotation limit; and if the required rotation exceeds the rotation limit, determine an alternative second position for which an alternative required rotation is below the rotation limit; and control the actuating system in accordance with the alternative second position.

Limiting the translation and/or rotation to the respective limits may have the advantage that the human subject is comfortable on the seating platform without risking or even fearing to fall off. In addition, it may be helpful to stay within the acceleration limit.

The present disclosure further relates to a method for mobilizing a low back of a human subject. Although the method can be performed with the system according to the present disclosure; neither the system, nor the method is limited thereto. Features explained herein with reference to the system have the same meaning with respect to the method unless explicitly defined otherwise. Features explained with reference to the system can be applied mutatis mutandis to the method to achieve the similar advantages, and vice versa.

One or more objects of the present disclosure can be achieved with a method for mobilizing a low back of a human subject, wherein the method includes the following steps: arranging a human subject on a seating platform of a system according to any of the embodiments described herein; moving the seating platform while the human subject is seated on thereon.

One or more objects of the present disclosure can be achieved with a method for mobilizing a low back of a human subject, wherein the method includes the following steps:
arranging a human subject on a seating platform, wherein
the buttocks of the human subject are supported by a seating surface of a seat of the seating platform, wherein a first centre axis of the seating surface extends a first horizontal direction; and
preferably the legs of the human subject are arranged in front of the seat when seen in a second horizontal direction, wherein the second horizontal direction is perpendicular to the first horizontal direction;
moving the seating platform with a plurality of degrees of freedom, wherein preferably one of the degrees of freedom is a rotation around a horizontal rotation axis with extends parallel to the first horizontal direction, wherein preferably the horizontal rotation axis is offset from the first centre axis when seen in the second horizontal direction.

The method can e.g. be a non-medical method. The method can e.g. be a non-therapeutical method. The subject can e.g. be a healthy subject. The method can e.g. be a method for training (muscles, and/or joints, and/or articulations, and/or tendons of) a low back.

The human subject can e.g. be a patient.

In embodiments, the horizontal rotation axis is arranged behind the second centre axis when seen in the first horizontal direction.

In embodiments, the human subject is arranged on the seating platform with the back being positioned substantially above the horizontal rotation axis.

In embodiments, the human subject is supported backrestless, at least during use.

In embodiments, the feet of the human subject are arranged on a footrest. The footrest may e.g. be arranged in front of the seat when seen in the second horizontal direction. The footrest may e.g. include a footresting surface, wherein the footresting surface extends at an acute angle to the horizontal when seen in the second horizontal direction. Optionally, the footresting surface may extend partially upwards when seen in a forward direction.

In embodiments, at least a part of the upper legs of the human subject, optionally substantially the entire upper legs are supported by the seat, e.g. the seating surface. Optionally the upper legs are positioned horizontally, when the seating platform is in rest position or begin position.

In embodiments, the acceleration of the seating platform is limited to predetermined acceleration limit. For example, the acceleration limit may include a translational acceleration limit, which may e.g. be 4 m/s² or less, e.g. 2.5 m/s², e.g. 1.5 m/s². For example, the acceleration limit may include a rotational acceleration limit, which may e.g. be 70°/s² or less, e.g. 58°/s², e.g. be 45°/s². Limiting the acceleration to the acceleration limit can be achieved by any of the ways described herein, e.g. with reference to the control unit.

In embodiments, the method includes helping the human subject maintain a straight sitting position on the seating surface, e.g. using an auxiliary system.

In embodiments, the method includes moving the seating platform in six degrees freedom.

In embodiments, the method includes moving the seating platform at a low frequency, e.g. below 50 Hz, e.g. below 10 Hz, e.g. below 5 Hz, e.g. below 2 Hz.

In embodiments, the method includes moving the seating platform unpredictable for the human subject. This can be achieved in any of the ways described herein.

In embodiments, the method includes moving the seating platform with a reproducible movement. This can be achieved in any of the ways described herein.

In embodiments, the method includes controlling, for example based on an intensity input, the intensity of the movement.

In embodiments, the method includes limiting the translation of the seating platform to predetermined translation limit.

In embodiments, the method includes limiting the rotation of the seating platform to predetermined rotation limit.

In embodiments, the method includes bringing the human subject out of balance (e.g. by moving the seating platform with the actuating system), and forcing the human subject to restore the balance by mobilizing the low back muscles.

The present disclosure further relates to a method for arranging a human subject on a seating platform, wherein the buttocks of the human subject is positioned on a seating surface of a seat of the seating platform, wherein a first centre axis of the seating surface extends a first horizontal direction; and the legs of the human subject are positioned in front of the seat when seen in a second horizontal direction, wherein the second horizontal direction is perpendicular to the first horizontal direction; wherein an actuating system is configured to move seating platform with a plurality of degrees of freedom, wherein preferably one of the degrees of freedom is a rotation around a horizontal rotation axis with extends parallel to the first horizontal direction, wherein preferably the horizontal rotation axis is offset from the first centre axis when seen in the second horizontal direction. The method can further e.g. include a step of seating the human subject with the back being positioned substantially above the horizontal rotation axis. In addition, any of the features or steps explained herein with reference to the system or method for mobilizing a low back of a human subject may be added to the method for arranging a human subject on a seating platform, to achieve similar advantages.

The present disclosure further relates to non-transitory computer-readable instructions configured to, when executed, cause a control unit of a system for mobilizing a low back of a human subject to control an actuating system to move a seating platform. For example, the system may be a system according to any of the embodiments described herein. For example, the control unit may control the actuating system to move the seating platform according to any of the movements described herein.

### BRIEF DESCRIPTION OF THE DRAWINGS

Exemplary embodiments of the present disclosure are described using the figures. It is to be understood that these figures merely serve as example of how the present disclosure can be implemented and are in no way intended to be construed as limiting for the scope of the present disclosure and the claims. Like features are indicated by like reference numerals along the figures. In the figures:

FIG. 1a: schematically shows a front view of a system for mobilizing a low back of a human subject in a first embodiment;

FIG. 1b: schematically shows a side view of the system;

FIG. 1c: schematically shows a top view of the system;

FIG. 1d: schematically shows a cross-section AA indicated in FIG. 1a;

FIG. 2a: schematically shows a front view of a system for mobilizing a low back of a human subject in a second embodiment;

FIG. 2b: schematically shows a cross-section AA indicated in FIG. 2a;

FIG. 3: schematically shows a side view of a system for mobilizing a low back of a human subject in a third embodiment;

FIG. 4: schematically illustrates a Stewart platform that can be used in the actuating system;

FIG. 5: schematically illustrates a control unit for controlling the actuating system.

### DETAILED DESCRIPTION

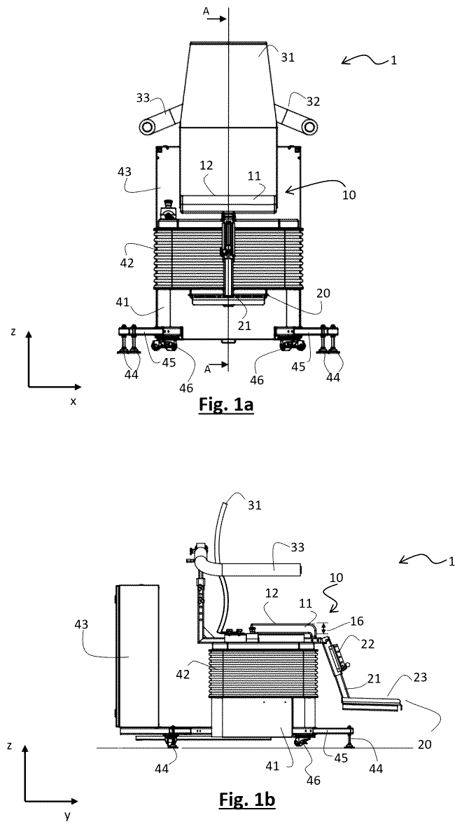

FIG. 1a-1d schematically show a system 1 for mobilizing a low back of a human subject in a first embodiment, wherein FIG. 1a shows a front view, FIG. 1b shows a side view, FIG. 1c shows a top view, and FIG. 1d shows a cross-section.

The system 1 includes a seating platform 10 having a seat 11. The seat 11 has a seating surface 12 on which the human subject can sit. As is explained further below, the seat 11 will be moved to mobilize the low back of the human subject. In particular, said movement will bring the human subject out of balance, and the human subject will be forced to use the low back to restore the balance.

In the figures, three direction x, y, z are schematically indicated with a coordinate system. The first direction x is a first horizontal direction x. The first horizontal direction x extends parallel to a direction between a left-handed and a right-handed side of the human subject, when the human subject is seated on the seating platform. The second direction y is a second horizontal direction y. The second horizontal direction y extends parallel to a direction between a rear-side and a front-side of the human subject, when the human subject is seated on the seating platform. When reference herein is made to “behind”, this is meant at the rear-side, and “in front” is meant at the front-side. The third direction z is a vertical direction.

As is best visible in FIG. 1c, the seating surface 12 has a substantially rectangular shape when seen in top view. Moreover, the seating surface 12 is relatively large. That is, a length 14 and a width 15 are relatively large, in particular in comparison with a height 16 (FIG. 1b). The relatively large length 14 provides support to both the buttocks and the upper legs of the human subject when the human subject is seated. Moreover, it is natural (because of the shape of the seating surface 12) for the human subject to sit in a position where the upper legs are arranged horizontally and supported by the seating surface 12. The relatively large width 15 makes it unpractical for the human subject to arrange the legs or feet next to the seat 11. Instead, the human subject will arrange those in front of the seat 12.

In the shown example, the seating platform 10 includes a footrest 20 in front of the seat 11. When the human subject is seated, the feet are supported by the footrest 20, in particular on a footresting surface 23. In this example a single footresting surface 23 is provided for both feet, but in other embodiments it is possible that the footrest includes a left footresting surface for the left foot and a right footresting surface for the right foot.

The footrest 20 is connected to the seat 11 via a connection bar 21. A size adjustment mechanism 22 is further provided to manually adjust the length of the connection bar 21 to the size of the human subject. This allows to ensure the right position of the feet of the human subject regardless of the length of the human subject. During use, however, the footrest 20 is rigidly connected to the seat 11 via the connection bar 21. The footrest 20 thus moves along with the seat 11 during use. It has been found that this improves the mobilization of the low back, since the human subject must rely more on the low back instead of the legs to restore the balance when the seat 11 is moving.

FIG. 1c further illustrates that the footresting surface 23 can include an anti-slip surface 24, e.g. a grating. This prevents the feet from slipping around during the movement of the seat 11, and even makes it harder for the human subject to move the feet on the human subject's own initiative. This further improves the mobilization of the low back.

The system 1 includes legs 45 and adaptable feet 44. The feet 44 can be adapted to make sure the system 1 is arranged level. The system 1 further includes supports 46 which can be unfolded to come into contact with the ground surface for supporting the system 1 on said ground surface.

FIG. 1a-1d further illustrate that the seating platform 10 may include a back-safeguard 31 and side-safeguards 32, 33. The back-safeguard 31 prevents the human subject from falling backwards of the seat 11 during use. The side-safeguards 32, 33 prevent the human subject from falling sideways of the seat 11. In this example, the side-safeguards 32, 33 are embodied as a left arm-rail 32 and a right arm-rail 33. This allows the human subject to grab the side-safeguards 32, 33 with the hands when needed.

The back-safeguard 31 and the side-safeguards 32, 33 are provided to provide safety to the human subject, but are not intended to support the human subject during normal use. It can be seen in FIG. 1a-1b that they are arranged relatively far from the seat 11. The back-safeguard 31 is arranged at a distance from the seating surface 12 when seen in the second horizontal direction y, and the side-safeguards 32, 33 at a distance when seen in the first horizontal direction x. This makes it unpractical for the human subject to rest the back and/or arms of the safeguards 31, 32, 33 during use. Thus, during use, the seating platform 10 is configured to support the human subject backrestless and armrestless. The system 1 supports the human subject (during use) only below the waist. The system 1 supports only at the buttocks, legs, and feet. The system 1 does not include any support elements for supporting body parts of the user above the waist during use. Indeed, all supports of the system that are configured to engage the human subject during use (in particular the seating surface 12 and the footresting surface 23) engage a body part below the waist.

During use, the human subject is supported while allowing the human subject to move freely above the waist. The system 1 brings the human subject out of balance by moving the seating platform, and forces the human subject to restore the balance by mobilizing the low back muscles because the human subject is not supported above the waist. The human subject is forced to use the low back to restore the balance rather than e.g. find support in a backrest and/or armrest. This enhances the mobilization of the low back.

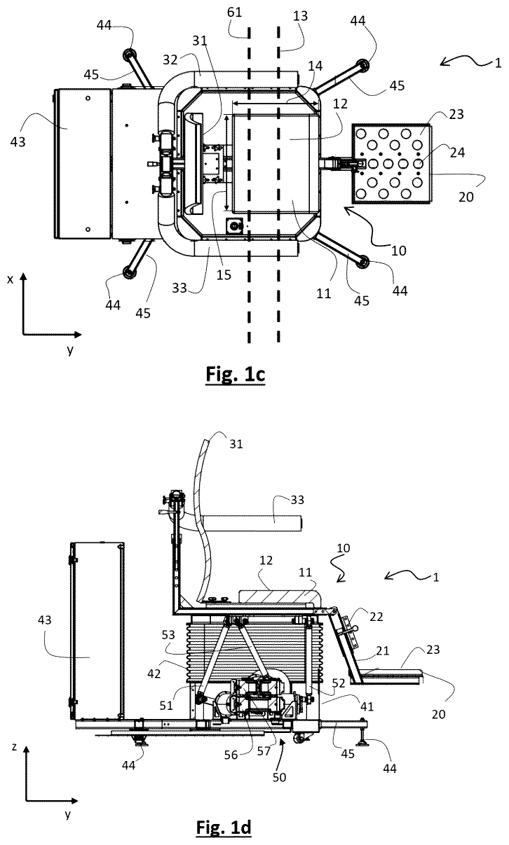

FIG. 2a-2b schematically show another embodiment of a system 2 for mobilizing a low back of a human subject, which includes several similarities to the embodiment shown in FIG. 1a-1d. Similar features are therefore indicated by the same reference numerals. Nevertheless, it is noted that the mere fact that a reference numeral is not explicitly indicated in FIG. 2a-2b, does not necessarily imply that this feature is not or cannot be present in the embodiment shown in FIG. 2a-2b.

The main difference of the embodiment shown in FIG. 2a-2b in comparison with the embodiment shown in FIG. 1 a-1d, is that the back-safeguard 30 and the side-safeguards 31, 32 have been omitted. Since these features are only used for safety measure, the functionality during normal use is not impaired. The system 2 may further be configured to move the seating platform 10 within an acceleration limit (as explained further below) to prevent any risk of the human subject falling off.

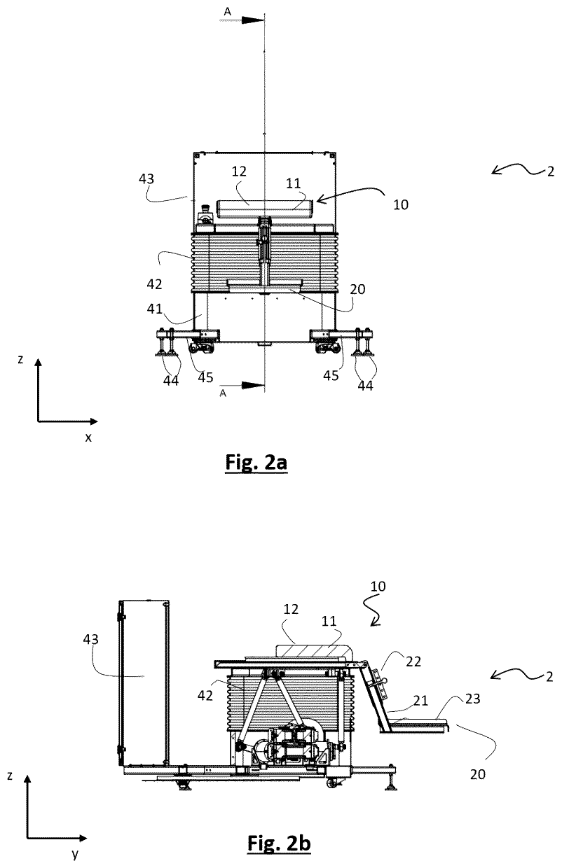

FIG. 3 shown another embodiment of a system 2 for mobilizing a low back of a human subject, which includes several similarities to the embodiment shown in FIG. 1a-1d; 2a-2b. Similar features are therefore indicated by the same reference numerals. Nevertheless, it is noted that the mere fact that a reference numeral is not explicitly indicated in FIG. 3, does not necessarily imply that this feature is not or cannot be present in the embodiment shown in FIG. 3.

A difference of the embodiment shown in FIG. 3 in comparison to the embodiments shown in previous figures, is the footrest 20a. As illustrated in FIG. 3, the footresting surface 23a extends at an acute angle 24 to the horizontal. In particular, the footresting surface 23a extends partially upwards when seen in forward direction y. This causes the human subject to use the low back more for restoring the balance during movement of the seat.

FIG. 3 further schematically illustrates an auxiliary system 91, which in this case is a mirror 92. The mirror 92 is arranged in front of the seating platform 10, such that the human subject can see himself in the mirror when being seated on the seating platform 10. It has been found this incentivizes human subjects to achieve and maintain a straight sitting position. The straight sitting position improves the effectiveness of the system 3.

The systems 1, 2, 3 shown in the figures include an actuating system 50 for moving the seating platform 10. The actuating system 50 is best illustrated in the cross-section shown in FIG. 1d, since it otherwise not clearly visible behind bellows 42. The actuating system 50 includes a plurality of actuators 56, 57, in this case electrical motors 56, 57 that move intermediate bars 51, 52, 53. The intermediate bars 51, 52, 53 are connected to the seating platform 10. The motors 56, 57 can move the seating platform 10 by moving the intermediate bars 51, 52, 53. It is noted that not all motors 56, 57 and intermediate bars 51, 52, 53 are visible in this figure. In the present example the actuating system 50 is configured to move the seating platform 10 in six degrees of freedom, for which six motors 56, 57 and six intermediate bars 51, 52, 53 are provided.

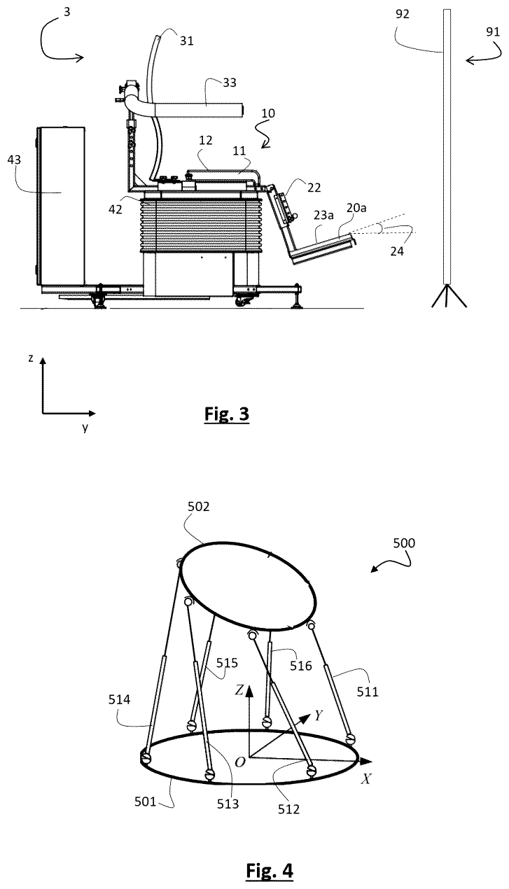

FIG. 4 schematically illustrates an example of how the actuating system can be implemented to achieve the six degrees of freedom. In this example, the actuating system includes a Stewart platform 500. The Stewart platform 500 has a baseplate 501 and a top plate 502. Six bars 511, 512, 513, 514, 515, 516 are provided between the baseplate 501 and top plate 502. In this case each of the bars 511-516 is part an actuator. Each bar 511-516 can be made shorter or longer by the respective actuator. By doing this, the top plate 502 is moved relative to the baseplate 501. Having six bars 511-516 allows to move the top plate 502 in six degrees of freedom, including three translational degrees of freedom and three rotational degrees of freedom. The seating platform of system shown in the previous figure can e.g. be arranged on the top plate 502, or the top plate 502 can be part of the seating platform. As such, the seating platform can also be moved in six degrees of freedom.

Although the actuating system can be embodied in several ways and with different numbers of degrees of freedom, in some embodiments those degrees of freedom include at least one rotational degree of freedom around the horizontal rotation axis 61 that is indicated in FIG. 1c. As can be seen, the horizontal rotation axis 61 extends substantially horizontal to the first horizontal direction x. It will be understood, however, that during use the horizontal rotation axis 61 may shift a bit both translationally and rotationally due to movement of the seating platform 10 in the other degrees of freedom.

The actuating system 50 can thus rotate the seating platform 10 around the horizontal rotation axis 61. When a human subject is sitting on the seating platform 10, this rotation will cause the human subject to be tilted forwards of backwards. The human subject is brought out of balance, and will naturally attempt to restore the balance. Doing this, the human subject will mobilize the low back. This mobilization will contribute to treating the low back (e.g. the low back muscles, the lumbosacral joint, and/or the disks in the low back) when there is a low back injury.

It will be understood, however, that an actuating system 50 with a Stewart-platform as shown in these figures is just one possible implementation. Different actuating systems are possible.

FIG. 1c also illustrates a centre axis 13 of the seat 11 and the seating surface 12, which also extends in the first direction x. Again, it will be understood that during use the centre axis 61 may shift a bit due to movement of the seating platform 10. Generally speaking, however, the centre axis 13 extends parallel to the horizontal rotation axis 61.

FIG. 1c illustrates that the centre axis 13 is offset from the horizontal rotation axis 61 when seen in the second direction y. In particular, the horizontal rotation axis 61 is arranged behind the centre axis 13. As such, the seating surface 10 is configured to seat the human subject with the back being positioned substantially above the horizontal rotation axis 61. Indeed, it has been found that this way, human subjects instinctively sit on the seating platform with the back position above the horizontal rotation axis 61. This has been found to be advantageous, as the human subject will use the low back more to restore the balance during movement of the seating platform 10.

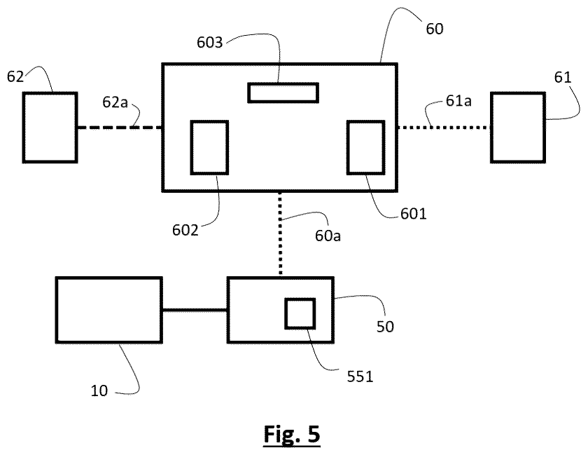

FIGS. 1a-3 further illustrate a control box 43. The control box 43 may include electronic components, e.g. including a control unit configured to control the actuating system 50. An example of how the control unit 60 can be implemented is schematically illustrated in FIG. 5.

The control unit 60 includes a memory 601, a processing unit 602, and a communication unit 603. The communication unit 603 can e.g. be configured for wired and/or wireless communication, e.g. via one or more communication terminals of the control unit 60. The memory 601 can store computer readable instructions, predetermined equations, an acceleration limit, a rotation limit, a translation limit, etc. The processing unit 601 is configured for performing processing functions, e.g. based on computer readable instructions stored on the memory 601.

The control unit 60 can generate a control signal 60a and transmit this to the actuating system 50. Based on the control signal 60a, the actuating system 50 moves the actuators. As such, the seating platform is moved in the different degrees of freedom. In the shown example, the actuating system 50 includes an actuating system control unit 551. The actuating system control unit 551 converts the control signal 60a into control signals for the individual actuators. In other embodiments, it is possible that the control unit 60 transmits control signals for the individual actuators, e.g. within the control signal 60a.

The control unit 60 is configured to move the seating platform 10 at a low frequency, e.g. below 50 Hz, e.g. below 10 Hz, e.g. below 5 Hz, e.g. below 2 Hz. Thus, the human subject is not subjected to vibrations. It has been found that the low back is best mobilized in a passive/reactive manner when the movement is at said low frequencies.

The control unit 60 is configured to limit the acceleration of the seating platform 10 to predetermined acceleration limit. The acceleration limit includes a translational acceleration limit, in this example is set at 2.5 m/s² . The acceleration limit also includes a rotational acceleration limit, which is set at 58°/s².

The control unit 60 is configured to limit the translation of the seating platform 10 to predetermined translation limit of 12 cm. The control unit 60 is configured to limit the rotation of the seating platform 10 to predetermined rotation limit of 10°.

The control unit 60 is configured to control the movement of the seating platform 10 to be unpredictable for the human subject. If the movement becomes predictable, the human subject is able to prepare for the next movement. In addition, the control unit 60 is configured to control the movement of the seating platform 10 to be reproducible.

A combination of the unpredictable yet reproducible movement can e.g. be achieved as follows. The control unit 60 is configured to determine a desired subsequent position in each degree of freedom according to a predetermined equation per degree of freedom, wherein each predetermined equation is a combination of a plurality of periodic functions having different periods and also different amplitudes. The predetermined equation for each degree of freedom may include four periodic functions. The periodic functions may be sinusoidal functions. The smallest period and the largest period of the plurality of periodic functions of the predetermined equation of the translational degrees of freedom is within a ratio of 1:2. The smallest period and the largest period of the plurality of periodic functions of the predetermined equation of the rotational degrees of freedom is within a ratio of 1:5.

For example, the translation in the first direction X (e.g. first horizontal direction) can be defined by the following formula: Xₜᵣₐₙₛₗₐₜᵢₒₙ=0.01*Sin(2π*dt)+0.04*Cos(21π*0.05*dt)+0.015*Sin(2π*0.9*dt)+0.01*Sin(2π*0.8*dt).

For example, the translation in the second direction Y (e.g. second horizontal direction) can be defined by the following formula: Yₜᵣₐₙₛₗₐₜᵢₒₙ=0.02*Sin(2π*dt)+0.04*Sin(21π*0.05*dt)+0.015*Sin(2π*0.9*dt)+0.01*Sin(2π*1.4*dt).

For example, the translation in the third direction Z (e.g. vertical direction) can be defined by the following formula: Zₜᵣₐₙₛₗₐₜᵢₒₙ=0.0075*Cos(2*π*dt)+0.035*Cos(21π*0.05*dt)+0.02*Sin(2π*0.9*dt)+0.005*Cos(2π*1.4*dt).

For example, the rotation around a rotation axis extending in the first direction X can be defined by the following formula: Xᵣₒₜₐₜᵢₒₙ=0.7*Sin(dt)+0.9*Sin(0.7*dt)+2*Sin(0.2*dt).

For example, the rotation around a rotation axis extending in the second direction Y can be defined by the following formula: Yᵣₒₜₐₜᵢₒₙ=0.7*Cos(dt)−0.9*Cos(0.7*dt)+2*Sin(0.2*dt).

For example, the rotation around a rotation axis extending in the third direction X can be defined by the following formula: Zᵣₒₜₐₜᵢₒₙ=0.7*Sin(dt)−0.9*Sin(0.7*dt)+2*Sin(0.2*dt).

In addition to these predetermined equations, the control unit 60 may check for each subsequent position whether one of the accelerating limit, translation limit, or rotation limit will be exceeded when moving the seating platform 10 to the subsequent position. When this is the case, the control unit 60 may determine an alternative subsequent position, or move the seating platform slower towards the subsequent position.

FIG. 5 further illustrates an intensity controller 61. The intensity controller 61 can e.g. be a button or rotary know which the practitioner or human subject can use to change the intensity of the movement. An intensity signal 61a is transmitted to the control unit 60. The control unit 60 controls, based on the intensity input, the intensity of the movement by adapting the predetermined functions. The control unit 60 can scale the amplitude and/or the period of each periodic function. For the rotational degrees of freedom the amplitude of each periodic function can be scaled between 0 and 1.35. For the translational degrees of freedom the amplitude of each periodic function can be scaled between 0 and 0.75. For the rotational degrees of freedom the period of each periodic function can be scaled between 0 and 1.5. For the translational degrees of freedom the period of each periodic function can be scaled between 0 and 1.5.

FIG. 5 further illustrates an external control unit 62. The external control unit 62 may e.g. be part of a cloud-based platform, allowing a practitioner or human subject to access historical data and/or submit preference. The control unit 60 and external control unit 62a can communicate via communication signal 62a, which may be using an internet protocol communication, optionally wireless, e.g. using Wi-Fi, 4G, or 5G.

The systems and methods shown in the figures can thus be used for seating a human subject on the seating platform 10, and then moving the seating platform 10. This movement will cause mobilization of the low back of the human subject. Several measures have been explained to improve this mobilization. Said measures can be used separately or in combination, as shown. The systems and methods can be used for various uses. For example, the mobilization of the low back can be used to help a human subject in recovering from low back injuries. In those cases, the human subject can e.g. be considered a patient. The systems and methods can also be used to e.g. train the low back, e.g. for healthy human subjects. The systems and methods can thus be used for non-medical and/or non-therapeutical applications.

As required, detailed embodiments of the present disclosure are described herein; however, it is to be understood that the disclosed embodiments are merely examples of the present disclosure, which may be embodied in various ways. Therefore, specific structural and functional details disclosed herein are not to be construed as limiting, but merely as a basis for the claims and as a representative basis for teaching those skilled in the art to practice the present disclosure in various ways in virtually any suitable detailed structure. Not all of the objectives described need be achieved with particular embodiments.

Furthermore, the terms and expressions used herein are not intended to limit the present disclosure, but to provide an understandable description of examples of the presently disclosed invention. The words “a”, “an”, or “one” used herein mean one or more than one, unless otherwise indicated. The terms “a multiple of”, “a plurality” or “several” mean two or more than two. The words “comprise”, “include”, “contain” and “have” have an open meaning and do not exclude the presence of additional elements. Reference numerals in the claims should not be construed as limiting the invention.

The mere fact that certain technical features are described in different dependent claims still allows the possibility that a combination of these technical measures can be used advantageously.

A single processor or other unit can perform the functions of various components mentioned in the description and claims, e.g. of processing units or control units, or the functionality of a single processing unit or control unit described herein can in practice be distributed over multiple components, optionally physically separated of each other. Any communication between components can be wired or wireless by known methods.

The actions performed by the control unit can be implemented as a program, for example computer program, software application, or the like. The program can be executed using computer readable instructions. The program may include a subroutine, a function, a procedure, an object method, an object implementation, an executable application, a source code, an object code, a shared library/dynamic load library and/or other set of instructions designed for execution on a computer system.

A computer program or computer-readable instructions can be stored and/or distributed on a suitable medium, such as an optical storage medium or a solid-state medium supplied with or as part of other hardware, but can also be distributed in other forms, such as via internet or other wired or wireless telecommunication systems.

1. A system for mobilizing a low back of a human subject, wherein the system comprises:
a seating platform comprising a seat having a seating surface for supporting the buttocks of the human subject, wherein a first center axis of the seating surface extends a first horizontal direction, and wherein the seating platform is configured to seat the human subject with the human subject's legs in front of the seat when seen in a second horizontal direction, wherein the second horizontal direction is perpendicular to the first horizontal direction; and
an actuating system configured to move the seating platform with a plurality of degrees of freedom, wherein one of the degrees of freedom is a rotation around a horizontal rotation axis that extends parallel to the first horizontal direction,
wherein all supports of the system that are configured to engage the human subject during use are configured to engage a body part below the waist.

2-18. (canceled)

19. The system according to claim 1, wherein the horizontal rotation axis is offset from the first center axis when seen in the second horizontal direction.

20. The system according to claim 1, wherein the system is configured to support the human subject by only engaging body parts below the waist.

21. The system according to claim 1 wherein the system is configured to support the human subject in a manner that allows the human subject to move freely above the waist.

22. The system according to claim 1, wherein the seating platform is configured to support the human subject backrestless, at least during use, wherein:
the system does not comprise a backrest, and/or
the system comprises a back-safeguard, wherein the back-safeguard is implemented as a backrest at a distance from the seating surface when seen in the second horizontal direction.

23. The system according to claim 1, wherein the seating surface is configured to seat the human subject with the human subject's back being positioned above the horizontal rotation axis.

24. The system according to claim 1, wherein the system is configured to bring the human subject out of balance by moving the seating platform with the actuating system, thereby forcing the human subject to restore balance by mobilizing the low back muscles.

25. The system according to claim 1, wherein the seating platform comprises a footrest for supporting both feet of the human subject, wherein the footrest is arranged in front of the seat when seen in the second horizontal direction, wherein the footrest comprises a footresting surface, wherein the footresting surface extends at an acute angle to horizontal when seen in the second horizontal direction.

26. The system according to claim 1, further comprising an auxiliary system for helping the human subject maintain a straight sitting position on the seating surface.

27. The system according to claim 26, wherein the auxiliary system is a mirror arranged in front of the seating platform.

28. The system according to claim 1, wherein the seating surface is configured to support at least a part of the human subject's upper legs.

29. The system according to claim 1, wherein the actuating system is configured to move the seating platform in six degrees of freedom.

30. The system according to claim 29, wherein the actuating system is a Stewart-platform.

31. The system according to claim 1, wherein the control unit is configured to move the seating platform at a frequency below 5 Hz.

32. The system according to claim 1, wherein the control unit is configured to control the movement of the seating platform to be unpredictable for the human subject, and reproducible.

33. The system according to claim 1, wherein the control unit is configured to determine a desired subsequent position in each degree of freedom according to a predetermined equation per degree of freedom, wherein each predetermined equation is a combination of a plurality of periodic functions having different periods.

34. The system according to claim 33, wherein each predetermined equation is also a combination of different amplitudes.

35. The system according to claim 1, wherein the control unit is configured to limit translation of the seating platform to a predetermined translation limit, and to limit rotation of the seating platform to a predetermined rotation limit.

36. A method for mobilizing a low back of a human subject, wherein the method comprises:
arranging the human subject on a seating platform of the system according to claim 1; and
moving the seating platform while the human subject is seated thereon.

37. A method for mobilizing a low back of a human subject, wherein the method comprises:
arranging a human subject on a seating platform, wherein:
the buttocks of the human subject are supported by a seating surface of a seat of the seating platform, wherein a first centre axis of the seating surface extends a first horizontal direction; and
the legs of the human subject are arranged in front of the seat when seen in a second horizontal direction, wherein the second horizontal direction is perpendicular to the first horizontal direction; and
moving the seating platform with a plurality of degrees of freedom, wherein one of the degrees of freedom is a rotation around a horizontal rotation axis with extends parallel to the first horizontal direction, wherein the horizontal rotation axis is offset from the first centre axis when seen in the second horizontal direction.

38. A non-transitory computer-readable medium encoded with instructions configured to, when executed, cause a control unit of the system for mobilizing a low back of a human subject according to claim 1 to control the actuating system to move the seating platform.
